(19) United States
(12) Patent Application Publication
(10) Pub. No.: US 2016/0265495 A1
(43) Pub. Date: Sep. 15, 2016

(54) FUEL PUMP

(71) Applicant: DENSO CORPORATION, Aichi (JP)

(72) Inventors: Kiyoshi NAGATA, Kariya-city (JP); Yuuichirou OOTA, Kariya-city (JP); Hiromi SAKAI, Kariya-city (JP)

(21) Appl. No.: 15/033,334

(22) PCT Filed: Oct. 16, 2014
(86) PCT No.: PCT/JP2014/005242

§ 371 Date: Apr. 29, 2016

(30) Foreign Application Priority Data
Oct. 31, 2013 (JP) 2013-226975

(51) Int. Cl. F02M 37/20; F04D 13/06; F04D 29/043; F02M 37/22; F04D 29/18; F04D 29/70; F02M 37/08; F04D 3/00; F04D 29/041

(52) U.S. Cl. CPC F02M 37/20; F04D 3/005; F04D 13/06; F04D 29/043; F04D 29/0413; F04D 29/18; F04D 29/708; F02M 37/08; F02M 37/22

(57) ABSTRACT

A projection of a suction end cover has an outer circumferential surface serving as a sealing surface to be connected with a suction filter. A suction flow path is configured by an introduction hole in a bottomed cylindrical shape, and a connection hole. The introduction hole extends from the distal end of the projection of the suction end cover toward a pump chamber. The connection hole connects the introduction hole and the pump chamber. The introduction hole has a bottom surface that is located axially between a slide inner surface of the suction end cover and a bottom surface of a recess. The suction flow path can be increased in sectional area enough to reach a position in immediate front of the pump chamber with no change in outer diameter of a housing. By reducing fuel flow speed in the suction flow path and suppressing negative pressure in the suction flow path, generation of fuel vapor in the suction flow path can be inhibited even in a large flow rate area.

### CROSS REFERENCE TO RELATED APPLICATION

This application is based on Japanese Patent Application No. 2013-226975 filed on Oct. 31, 2013, the disclosure of which is incorporated herein by reference.

### TECHNICAL FIELD

The present disclosure relates to a fuel pump.

### BACKGROUND ART

There has been known a fuel pump including a cylindrical housing that accommodates a pump unit and a motor unit, and configured to suction, pressurize, and discharge fuel by driving, with the motor unit, to rotate an impeller in the pump unit. The fuel pump of this type is provided to a vehicle fuel tank or the like so as to pressure feed fuel to an engine.

A fuel pump disclosed in Patent Literature 1 includes a motor unit provided with a brushless motor and a pump unit provided with an impeller that has a ring surrounding the outer periphery of each vane. Use of a brushless motor solves problems caused by a brush motor, such as noise, sparks, and electrical noise generated by friction of the brush, as well as deterioration in durability due to wear of the brush. The impeller having the ring advantageously reduces clearance that influences efficiency inside the pump so as to improve pump efficiency.

There has recently been desired a fuel pump of the type mentioned above, provided with a high pressure filter to be mounted to a fuel tank having a tank hole diameter of 110 mm or the like. The fuel pump has a relatively small outer diameter of 38 mm or the like in view of mountability, and is configured to discharge at a large flow rate so that the single fuel pump is applicable to a flexible fuel vehicle (FFV) of large displacement, for example.

However, a pump having a conventional size and a maximum discharge flow rate as required has been achieved only by increasing impeller rotational speed. The fuel pump thus configured may cause a vapor lock phenomenon that fuel flow speed increases in a suction flow path and fuel vapor is generated by decompression boiling at high temperature, thereby failing to feed a required flow rate of fuel to an engine.

### PRIOR ART LITERATURE

### Patent Literature [Patent Literature 1] JP 2013-201820-A

### SUMMARY OF INVENTION

It is an object of the present disclosure to provide a fuel pump that inhibits occurrence of vapor lock even at an increased discharge flow rate, while mountability is maintained and life is secured by providing no brush.

According to an aspect of the present disclosure, a fuel pump includes a cylindrical housing, a suction end cover provided at a first end of the housing, a discharge end cover provided at a second end of the housing, a brushless motor provided between the suction end cover and the discharge end cover in the housing, a casing defining a pump chamber partitioning between the suction end cover and the casing in the housing, and an impeller rotatably provided in the pump chamber.

The suction end cover forms a cylindrical projection extending outward from the housing, and has a suction flow path penetrating the projection to be communicable with an exterior. The discharge end cover has a discharge flow path communicable with the exterior. The casing has a discharge hole penetrating from the pump chamber to the discharge end cover. The brushless motor includes an output shaft having an end inserted through the casing and extending into the pump chamber. The impeller includes a disc-shaped boss, a plurality of vanes, and an annular ring. The boss is torque-transmittably coupled to the end of the output shaft of the brushless motor. The plurality of vanes projects radially outward from the boss in different directions. The ring surrounds the vanes. The suction end cover has a recess depressed opposite to the impeller from a slide inner surface slidable with respect to the impeller. The recess has a bottom provided with a thrust bearing receiving the end of the output shaft.

The projection of the suction end cover has an outer circumferential surface serving as a sealing surface to be connected with a suction filter.

The suction flow path has an introduction hole in a bottomed cylindrical shape, and a connection hole. The introduction hole extends from a distal end surface of the projection of the suction end cover toward the pump chamber. The connection hole penetrates from the introduction hole to the pump chamber. The introduction hole has a bottom surface located axially between the slide inner surface of the suction end cover and a bottom surface of the recess.

In the fuel pump thus configured, the suction flow path can be increased in sectional area enough to reach a position in immediate front of the pump chamber with no change in outer diameter of the housing. Specifically, the suction filter attached to the outer circumferential surface of the projection of the suction end cover prevents decrease in substantial sectional area of the suction flow path due to a configuration in which a uniting duct of the suction filter is attached to an inner portion of the suction flow path. When the bottom surface of the introduction hole of the suction flow path is located closer to the slide inner surface relatively to the bottom surface of the recess, the introduction hole, which is provided in a portion with a relatively large sectional area of the suction flow path, can be extended to a position in immediate front of the pump chamber.

By reducing fuel flow speed in the suction flow path and suppressing negative pressure in the suction flow path, generation of fuel vapor in the suction flow path can be inhibited even in a large flow rate area. The present disclosure thus achieves inhibition of occurrence of vapor lock even at an increased discharge flow rate, while mountability is maintained.

### BRIEF DESCRIPTION OF DRAWINGS

The above-mentioned object as well as other objects, features, and advantages of the present disclosure will be further clarified in the following detailed description with reference to the accompanying drawings; in which

[FIG. 1]

FIG. 1 is an explanatory sectional view of a schematic configuration of a fuel pump according to a first embodiment of the present disclosure;

[FIG. 2]

FIG. 2 is a view from a casing side, of an impeller depicted in FIG. 1;

[FIG. 3]

FIG. 3 is an enlarged sectional view of a portion III indicated in FIG. 1;

[FIG. 4]

FIG. 4 is a sectional view in a rotational direction, of a suction flow path depicted in FIG. 3;

[FIG. 5]

FIG. 5 is a graph indicating the relation between an inner diameter of the suction flow path and a maximum discharge flow rate;

[FIG. 6]

FIG. 6 is a graph indicating the relation between a discharge flow rate and negative pressure generated by vapor lock;

[FIG. 7]

FIG. 7 is a graph indicating the relation between a dimensional ratio of depth to width of a pressurization flow path and pump efficiency;

[FIG. 8]

FIG. 8 is an enlarged sectional view of a pump unit of a fuel pump according to a second embodiment of the present disclosure;

[FIG. 9]

FIG. 9 is a chart indicating specifications of conventional fuel pumps, the fuel pump according to the first embodiment, and the fuel pump according to the second embodiment;

[FIG. 10]

FIG. 10 is an enlarged sectional view of a pump unit of a fuel pump according to a comparative embodiment; and

[FIG. 11]

FIG. 11 is a sectional view in a rotational direction, of a suction flow path depicted in FIG. 10.

### EMBODIMENTS FOR CARRYING OUT INVENTION

A plurality of embodiments of the present disclosure will be described below with reference to the drawings. Substantially identical configurations will be denoted by identical reference signs throughout the embodiments and will not be described repeatedly.

### First Embodiment

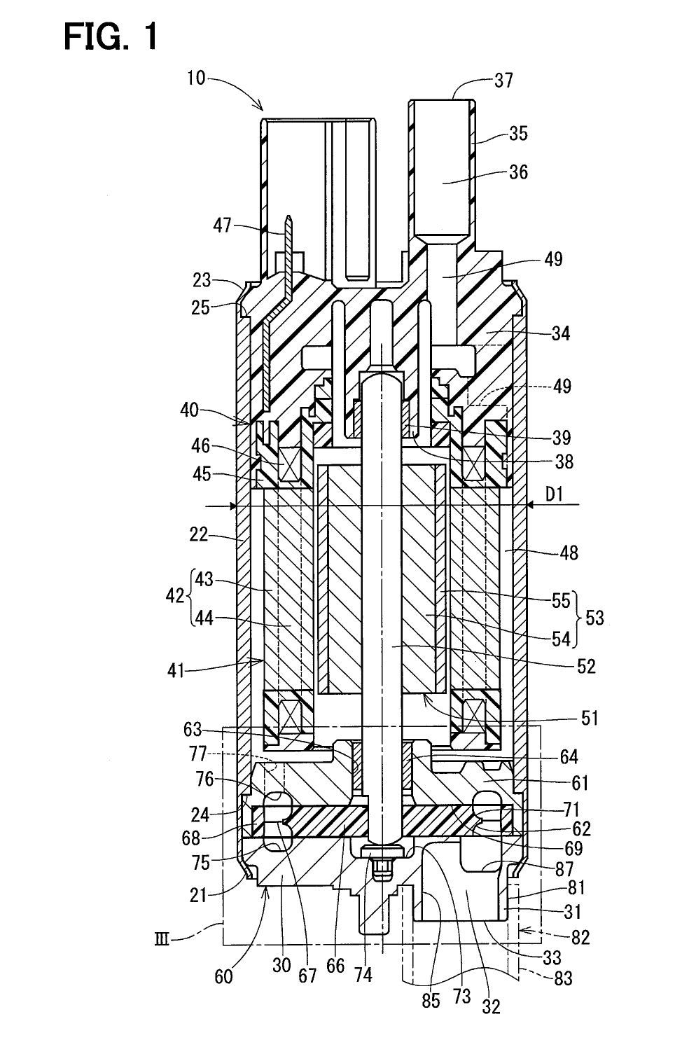

A fuel pump according to the first embodiment of the present disclosure is of an in-tank type and installed in a vehicle fuel tank. The fuel pump suctions fuel from a suction port 33 depicted at the bottom in FIG. 1, pressurizes, and discharges the fuel to an engine (not depicted) from a discharge port 37 depicted at the top in FIG. 1.

### Entire Configuration

The entire configuration of a fuel pump 10 will initially be described with reference to FIGS. 1 to 3.

As depicted in FIG. 1, the fuel pump 10 is roughly divided into a motor unit 40 and a pump unit 60, and has a contour configured by a housing 20, a suction end cover 30, and a discharge end cover 34.

### Contour

The housing 20 has a stepped cylindrical shape and includes a first cylindrical portion 21, a second cylindrical portion 22, and a third cylindrical portion 23 aligned in the mentioned order from an end in its axial direction. The first cylindrical portion 21 and the third cylindrical portion 23 are thinner than the second cylindrical portion 22. The second cylindrical portion 22 is provided, radially inside the first cylindrical portion 21, with an annular end surface 24, and is also provided, radially inside the third cylindrical portion 23, with an annular end surface 25.

The suction end cover 30 is provided at a first end of the housing 20, in other words, inside the end adjacent to the first cylindrical portion 21, and is fixed by an inwardly caulked edge of the first cylindrical portion 21. The suction end cover 30 has a projection 31 extending outward from the housing 20, and a suction flow path 32 axially penetrating the projection 31. The suction port 33 is an inlet of the suction flow path 32.

The discharge end cover 34 is provided at a second end of the housing 20, in other words, inside the end adjacent to the third cylindrical portion 23, and is fixed by an inwardly caulked edge of the third cylindrical portion 23. The discharge end cover 34 has a tube 35 projecting outward from the housing 20, and has a discharge flow path 36 axially penetrating the tube 35. The discharge port 37 is an outlet of the discharge flow path 36. The discharge end cover 34 also has a tube 38 projecting into the housing 20, and a bearing 39 is fitted in the tube 38.

### Motor Unit

The motor unit 40 is configured by a brushless motor and includes a stator 41 and a rotator 51. The stator 41 is accommodated in the housing 20, and has a stator core 42, an insulator 45, a coil 46, and a terminal 47. The stator core 42 is made of a magnetic material and has a cylindrical yoke 43 and a plurality of teeth 44 projecting radially inward from the yoke 43.

The insulator 45 is attached to the teeth 44 of the stator core 42. The coil 46 is wound around the insulator 45. The coil 46 according to the present embodiment includes a U-phase coil portion, a V-phase coil portion, and a W-phase coil portion. There are provided three terminals 47 (only one is depicted in FIG. 1) configured to connect the phase coil portions to an external control device.

The stator 41 is molded integrally with the discharge end cover 34. Specifically, the discharge end cover 34 is molded by cooling and solidifying molten resin poured into a cast provided therein with the stator 41. The stator 41 is thus fixed to the housing 20 via the discharge end cover 34. There is provided a fuel flow path 48 partitioning between the housing 20 and the stator 41. The discharge end cover 34 has a fuel flow path 49 connecting the fuel flow path 48 and the discharge flow path 36.

The rotator 51 is rotatably provided inside the stator 41, and has a shaft 52 and a rotor 53. The shaft 52 is rotatably supported by the bearing 39 and a bearing 64 to be described later. The rotor 53 has a cylindrical shape and is fitted and fixed to the shaft 52. The rotor 53 according to the present embodiment includes an inner core 54 press fitted to the shaft 52 and a plurality of permanent magnets 55 provided outside the inner core 54. The permanent magnets 55 are disposed such that radially outer ends have alternately different polarities in the circumferential direction.

The motor unit 40 thus configured generates a rotating magnetic field when currents having phase differences flow respectively to the phase coil portions in the coil 46 of the stator 41, and the rotating magnetic field attracts a magnetic pole of the rotator 51 to rotate the rotator 51.

### Pump Unit

The pump unit 60 includes the suction end cover 30, a casing 61, and an impeller 65. The suction end cover 30 configures the contour of the fuel pump 10 as well as configures the pump unit 60. The casing 61 has a bottomed cylindrical shape and is provided between the suction end cover 30 and the stator 41 and is axially held between the end surface 25 of the second cylindrical portion 22 of the housing 20 and the suction end cover 30. The casing 61 defines a pump chamber 62 partitioning between the suction end cover 30 and the casing 61. The casing 61 has a through hole 63 axially penetrating the center of the casing 61. The bearing 64 is fitted in the through hole 63.

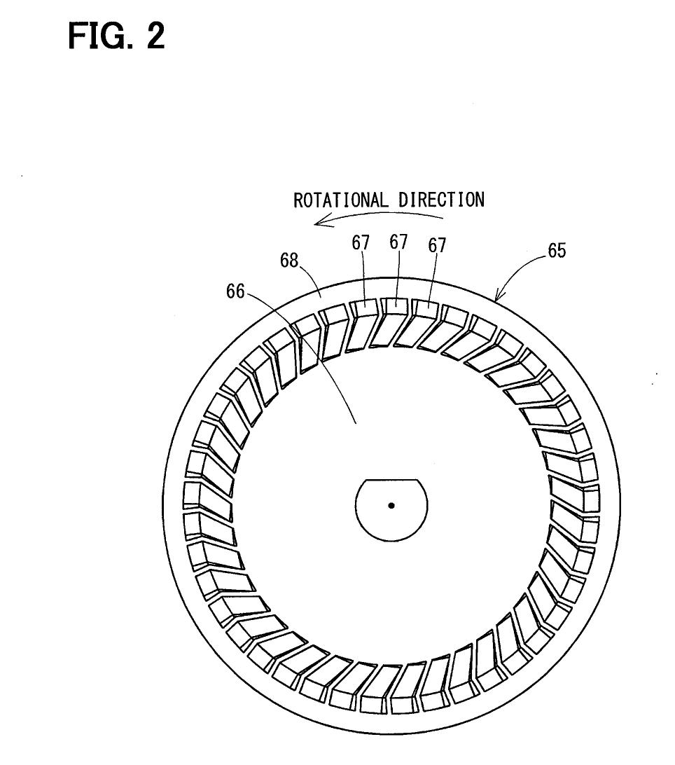

The impeller 65 is a disc-shaped vane wheel that is rotatably accommodated in the pump chamber 62. As depicted in FIGS. 1 and 2, the impeller 65 includes a disc-shaped boss 66, a plurality of vanes 67, and an annular ring 68. The boss 66 is torque-transmittably coupled to an end of the shaft 52 that extends through the through hole 63 of the casing 61 into the pump chamber 62. The plurality of vanes 67 projects radially outward from the boss 66 in different directions. The ring 68 surrounds the vanes 67.

The vanes 67 of the impeller 65 divide a space between the boss 66 and the ring 68 into a suction vane groove 69 adjacent to the suction flow path 32 and a discharge vane groove 71 adjacent to a discharge hole 77. As depicted in FIG. 1, the suction end cover 30 has a recess 73 depressed opposite to the impeller 65 from a slide inner surface 72 slidable with respect to the impeller 65. The recess 73 is provided, at the bottom, with a thrust bearing 74 configured to receive the end of the shaft 52.

The suction end cover 30 has a wall adjacent to the impeller 65, and the wall has a pressurization flow path 75 that is configured by a C-shaped groove extending circumferentially around the recess 73 when viewed in the axial direction. The suction flow path 32 communicates with an upstream end at a rear portion in the rotational direction, of the pressurization flow path 75. The casing 61 has a wall adjacent to the impeller 65, and the wall has a pressurization flow path 76 that is configured by a C-shaped groove extending circumferentially around the through hole 63 when viewed in the axial direction. The casing 61 has the discharge hole 77 that communicates with a downstream end at a front portion in the rotational direction, of the pressurization flow path 76 and penetrates from the bottom surface of the pressurization flow path 76 to the discharge end cover 34.

In the pump unit 60 thus configured, when the impeller 65 rotates along with the rotator 51 of the motor unit 40, fuel is suctioned into the pump chamber 62 from the suction port 33 via the suction flow path 32. This fuel flows to spirally circle between the impeller 65 and the pressurization flow paths 75 and 76, and is gradually pressurized as it flows from the suction flow path 32 to the discharge hole 77. The pressurized fuel is guided to the discharge flow path 36 via the discharge hole 77, the fuel flow path 48, and the fuel flow path 49, and is discharged from the discharge port 37.

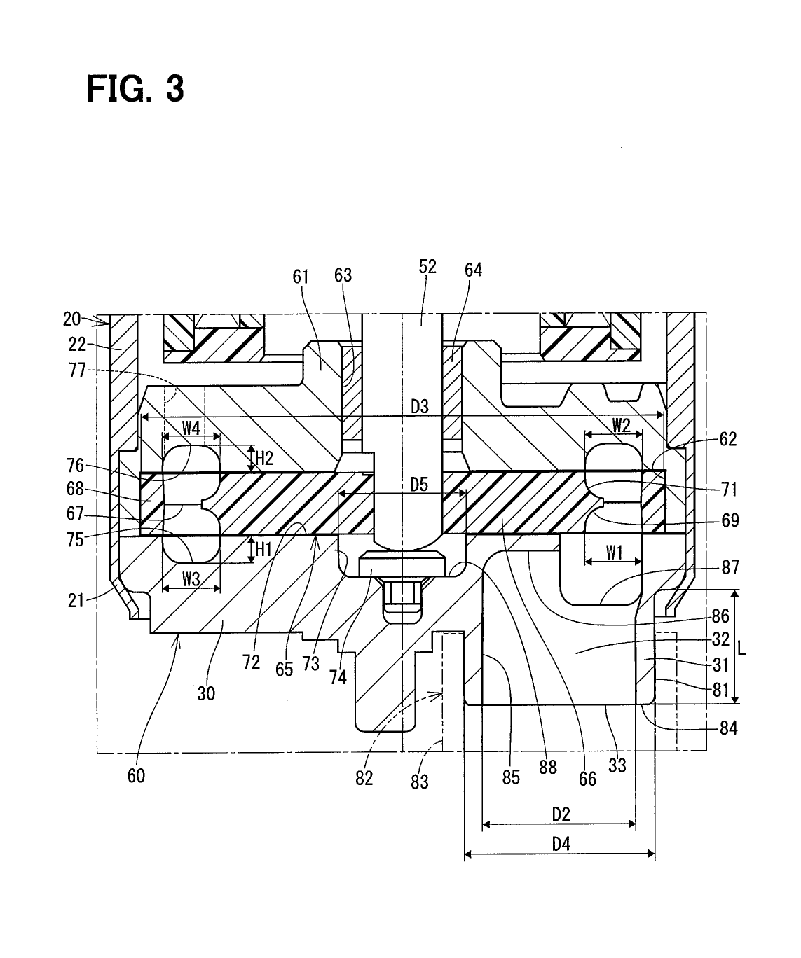

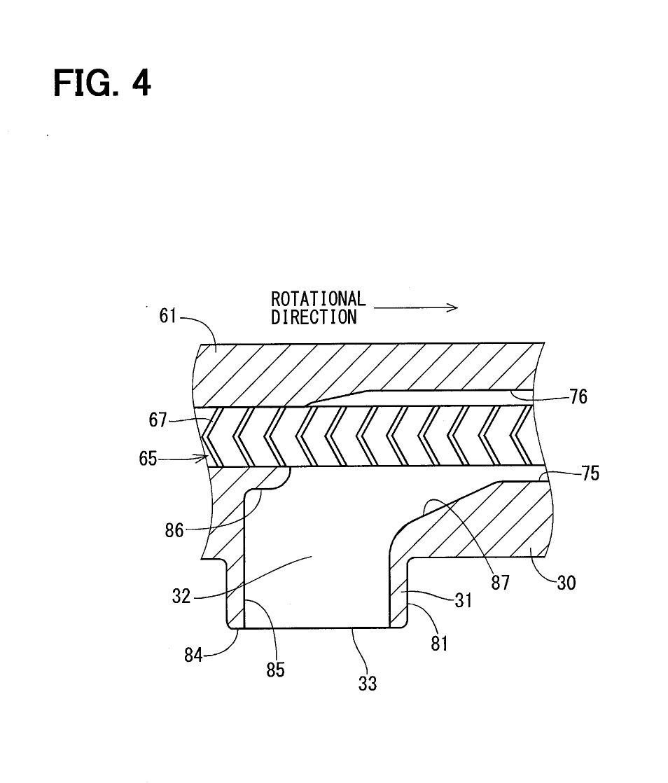

The configuration of the fuel pump 10 will be described in detail next with reference to FIGS. 1 and 3.

### Outer Diameter of Fuel Pump

The fuel pump 10 has an outer diameter D1 of 38 mm so as to achieve preferred mountability to a fuel tank having an inner diameter of 110 mm.

### Joining with Suction Filter

As depicted in FIGS. 1 and 3, the projection 31 of the suction end cover 30 has an outer circumferential surface 81 serving as a sealing surface to be connected with a suction filter 82. Specifically, the suction filter 82 has a uniting duct 83 that is fitted and fixed to the outer circumferential surface 81 of the projection 31 of the suction end cover 30.

### Position of Bottom Surface of Introduction Hole of Suction Flow Path

The suction flow path 32 is configured by an introduction hole 85 in a bottomed cylindrical shape, and a connection hole 87. The introduction hole 85 axially extends from a distal end surface 84 of the projection 31 of the suction end cover 30 toward the pump chamber 62. The connection hole 87 penetrates from the introduction hole 85 to the pump chamber 62. The introduction hole 85 has a bottom surface 86 that is located axially between the slide inner surface 72 of the suction end cover 30 and a bottom surface 88 of the recess 73.

### Inner Diameter of Introduction Hole of Suction Flow Path

The introduction hole 85 of the suction flow path 32 has an inner diameter D2 of 10 mm.

### Ratio of Vane Groove Width to Impeller Outer Diameter

The impeller 65 has an outer diameter D3 of 33.66 mm. The suction vane groove 69 has a radial width W1 and the discharge vane groove 71 has a radial width W2. The widths W1 and W2 are 4.00 mm. The ratio of the width W1 of the suction vane groove 69 to the outer diameter D3 of the impeller 65 and the ratio of the width W2 of the discharge vane groove 71 to the outer diameter D3 of the impeller 65 are 11.88%.

### Outer Diameter of Projection of Suction End Cover

The projection 31 of the suction end cover 30 has an outer diameter D4 of 12 mm.

### Ratio Between Depth and Width of Pressurization Flow Path

The pressurization flow path 75 has a radial width W3 and the pressurization flow path 76 has a radial width W4. The widths W3 and W4 are 4.0 mm. The pressurization flow path 75 has an axial depth H1 and the pressurization flow path 76 has an axial depth H2. The depths H1 and H2 are 1.6 mm. The value obtained by dividing the depth H1 by the width W3 of the pressurization flow path 75 and the value obtained by dividing the depth H2 by the width W4 of the pressurization flow path 76 are 0.40. The value obtained by dividing the depth H1 by the width W3 and the value obtained by dividing the depth H2 by the width W4 will be each referred to as a “dimensional ratio of the pressurization flow path”.

### Inner Diameter of Recess of Suction End Cover

The recess 73 of the suction end cover 30 has an inner diameter D5 of 8.5 mm.

### The Number of Impeller Vanes

The number of the vanes 67 of the impeller 65 is 41.

### Length of Projection of Suction End Cover

The projection 31 of the suction end cover 30 has an axial length L of 3.5 mm from the outer peripheral edge of the suction end cover 30.

### Material for Suction End Cover

The suction end cover 30 is formed by applying alumite treatment to the outer surface of an aluminum alloy molded product.

### Comparison with Comparative Embodiment

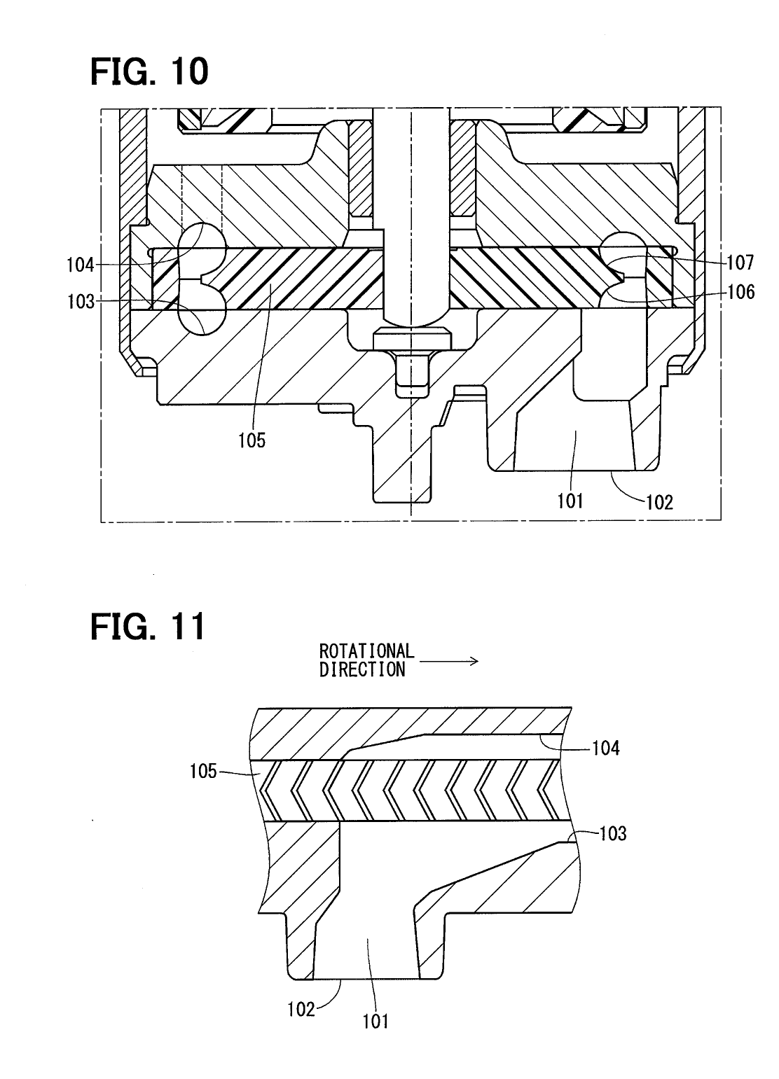

Advantages of the present embodiment will be clarified by comparison between a comparative embodiment depicted in FIGS. 10 and 11 and the present embodiment.

According to the comparative embodiment, a suction flow path 101 has an inlet or a suction port 102 having an inner diameter of 7 mm and is gradually reduced in diameter from the suction port 102. Widths of pressurization flow paths 103 and 104 and widths of vane grooves 106 and 107 of an impeller 105 are smaller than those according to the present embodiment.

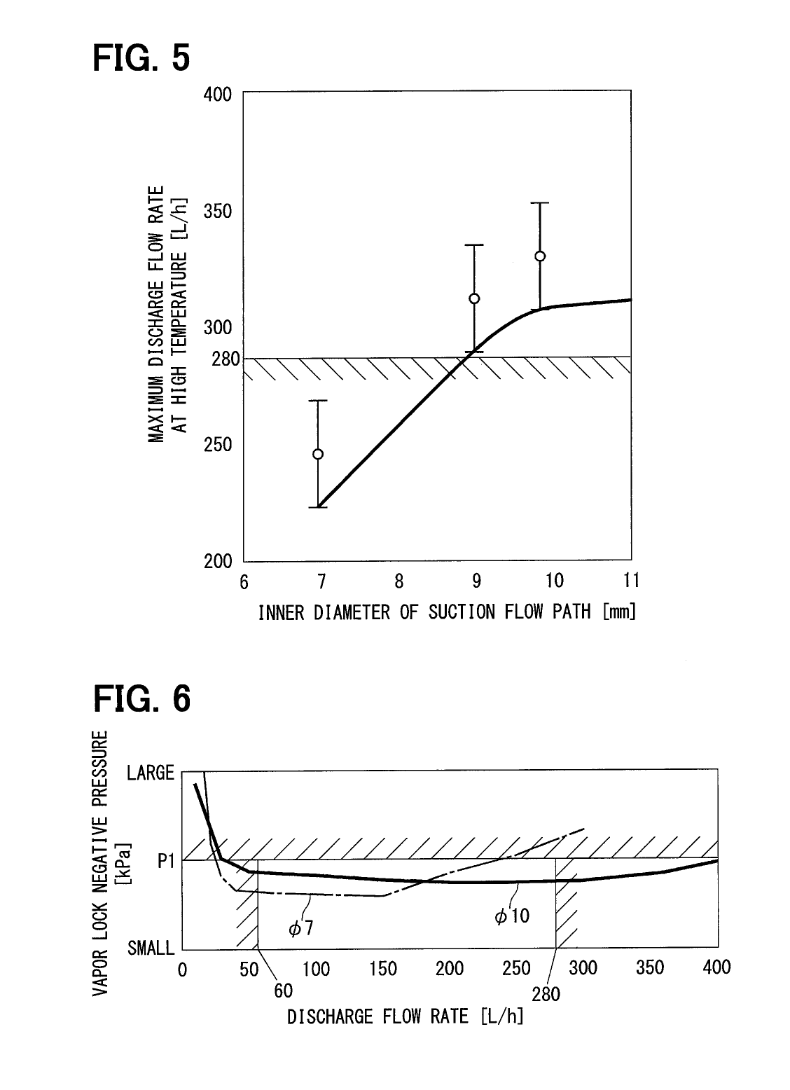

FIG. 5 is a graph indicating the relation between the inner diameter (suction port diameter) of the suction flow path and a maximum discharge flow rate at high temperature. Such “high temperature” is relatively high in an expected operational temperature range of a fuel pump. The maximum discharge flow rate is larger as the suction flow path has a larger inner diameter. The maximum discharge flow rate increases particularly when the inner diameter is from 7 mm to 9 mm. In a case where the maximum discharge flow rate has a large required value set to 280 L/h, the requirement is satisfied if the inner diameter is not less than 9 mm. The present embodiment satisfies the requirement whereas the comparative embodiment fails to satisfy the requirement.

FIG. 6 is a graph indicating the relation between the discharge flow rate and vapor lock negative pressure. The vapor lock negative pressure is generated by vapor lock. According to the comparative embodiment, the vapor lock negative pressure is kept small (with a large absolute value) when the discharge flow rate is 50 to 150 L/h, but the vapor lock negative pressure increases (with a smaller absolute value) when the discharge flow rate exceeds 250 L/h. In contrast, according to the present embodiment, the vapor lock negative pressure is kept small (with a large absolute value) even when the discharge flow rate exceeds 250 L/h. In a case where the discharge flow rate to be applied is set to the range of 60 to 280 L/h and the vapor lock negative pressure has a required value set to be not more than a predetermined value P1, the present embodiment satisfies the requirement whereas the comparative embodiment fails to satisfy the requirement. Even when the discharge flow rate has the maximum value at high temperature, an engine stall due to vapor lock and deterioration in drivability are inhibited in the present embodiment.

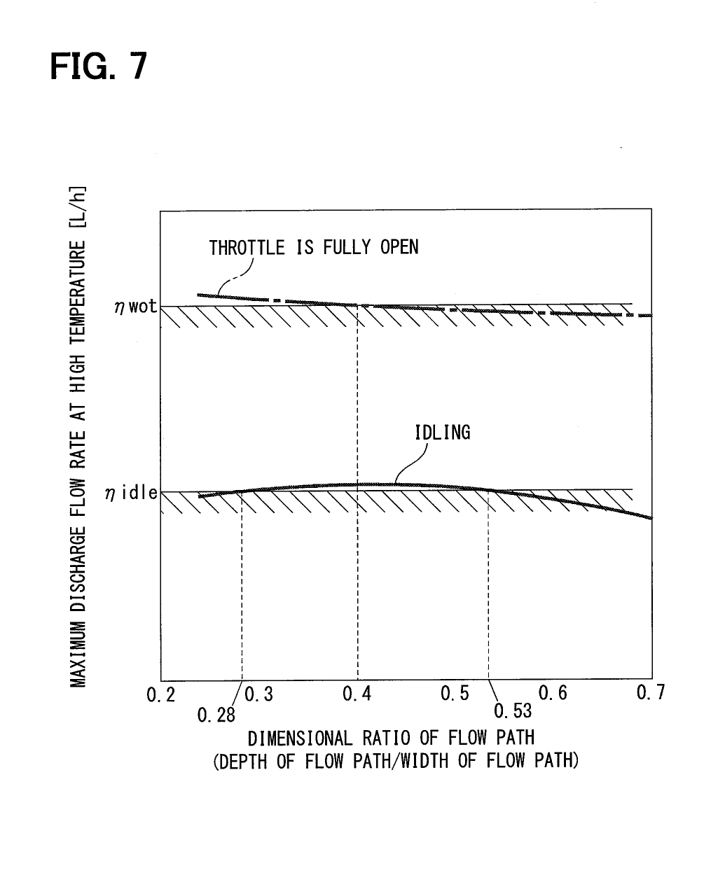

FIG. 7 is a graph indicating the relation between the dimensional ratio of the pressurization flow path and pump efficiency. Assume that a required value of pump efficiency in terms of an allowable current value during engine idling is referred to as required pump efficiency ηidle whereas a required value of pump efficiency in terms of an allowable current value in a case where an engine throttle is fully open is referred to as required pump efficiency ηwot. FIG. 7 includes a solid line depicting a curve during idling, in which the pump efficiency is not less than the required pump efficiency ηidle when the dimensional ratio of the pressurization flow path is not more than 0.4. FIG. 7 also includes a dashed line depicting a curve in the case where the throttle is fully open, in which the pump efficiency is not less than the required pump efficiency ηmot when the dimensional ratio of the pressurization flow path is 0.28 to 0.53. Accordingly, the requirement during idling and the requirement in the case where the throttle is fully open are satisfied when the dimensional ratio of the pressurization flow path is 0.28 to 0.4. In the present embodiment, the dimensional ratio of the pressurization flow path is set to 0.4 in consideration of the pump efficiency during idling.

### Effects

As described above, the fuel pump 10 according to the first embodiment has the outer diameter D1 of 38 mm. The fuel pump 10 can thus be mounted to a fuel tank having a tank hole diameter of 110 mm.

According to the first embodiment, the projection 31 of the suction end cover 30 has the outer circumferential surface 81 serving as a sealing surface to be connected with the suction filter 82. The suction flow path 32 is configured by the introduction hole 85 in the bottomed cylindrical shape, and the connection hole 87. The introduction hole 85 axially extends from the distal end surface 84 of the projection 31 of the suction end cover 30 toward the pump chamber 62. The connection hole 87 penetrates from the introduction hole 85 to the pump chamber 62. The introduction hole 85 has a bottom surface 86 that is located axially between the slide inner surface 72 of the suction end cover 30 and the bottom surface 88 of the recess 73.

In the fuel pump thus configured, the suction flow path 32 can be increased in sectional area enough to reach a position in immediate front of the pump chamber 62 with no change in outer diameter of the housing 20. Specifically, the uniting duct 83 of the suction filter 82 attached to the outer circumferential surface 81 of the projection 31 of the suction end cover 30 prevents decrease in substantial sectional area of the suction flow path 32 due to a configuration in which the uniting duct 83 is attached to an inner portion of the suction flow path 32. When the bottom surface 86 of the introduction hole 85 of the suction flow path 32 is located closer to the slide inner surface 72 relatively to the bottom surface 88 of the recess 73, the introduction hole 85, which is provided in a portion with a relatively large sectional area of the suction flow path 32, can be extended to a position in immediate front of the pump chamber 62.

By reducing fuel flow speed in the suction flow path 32 and suppressing negative pressure in the suction flow path 32, generation of fuel vapor in the suction flow path 32 can be inhibited even in a large flow rate area. The present embodiment thus inhibits occurrence of vapor lock even at an increased discharge flow rate, while mountability is maintained.

The introduction hole 85 of the suction flow path 32 according to the first embodiment has the inner diameter D2 of 10 mm.

It is thus possible to increase the maximum discharge flow rate at high temperature and inhibit occurrence of vapor lock when the discharge flow rate is large.

In the first embodiment, the ratio of the width W1 of the suction vane groove 69 to the outer diameter D3 of the impeller 65 and the ratio of the width W2 of the discharge vane groove 71 to the outer diameter D3 of the impeller 65 are 11.88%. The vane grooves 69 and 71 of the impeller 65 can thus be increased in capacity with no increase in size of the fuel pump 10. The discharge flow rate can be increased while mountability of the fuel pump 10 is maintained.

The projection 31 of the suction end cover 30 according to the first embodiment has the outer diameter D4 of 12 mm. There is limitation to shift the projection 31 radially outward with no intension to change the outer diameter of the fuel pump. By minimizing the outer diameter of the projection 31 to thin the projection 31, the suction flow path 32 can be shifted radially outward as much as possible. Fuel can thus be smoothly made to flow from the suction flow path 32 into the suction vane groove 69 of the impeller 65.

In the first embodiment, the value obtained by dividing the depth H1 by the width W3 of the pressurization flow path 75 and the value obtained by dividing the depth H2 by the width W4 of the pressurization flow path 76 are 0.40. It is thus possible to suppress circular flow speed in the pressurization flow paths 75 and 76 and inhibit fuel leakage from the pump chamber 62 so as to improve pump efficiency.

The recess 73 of the suction end cover 30 according to the first embodiment has the inner diameter D5 of 8.5 mm. With the recess 73 reduced in size as much as possible, even when the introduction hole 85 extended toward the pump chamber 62 is axially overlapped with the recess 73, the recess 73 can be provided with no interference with the introduction hole 85.

### Second Embodiment

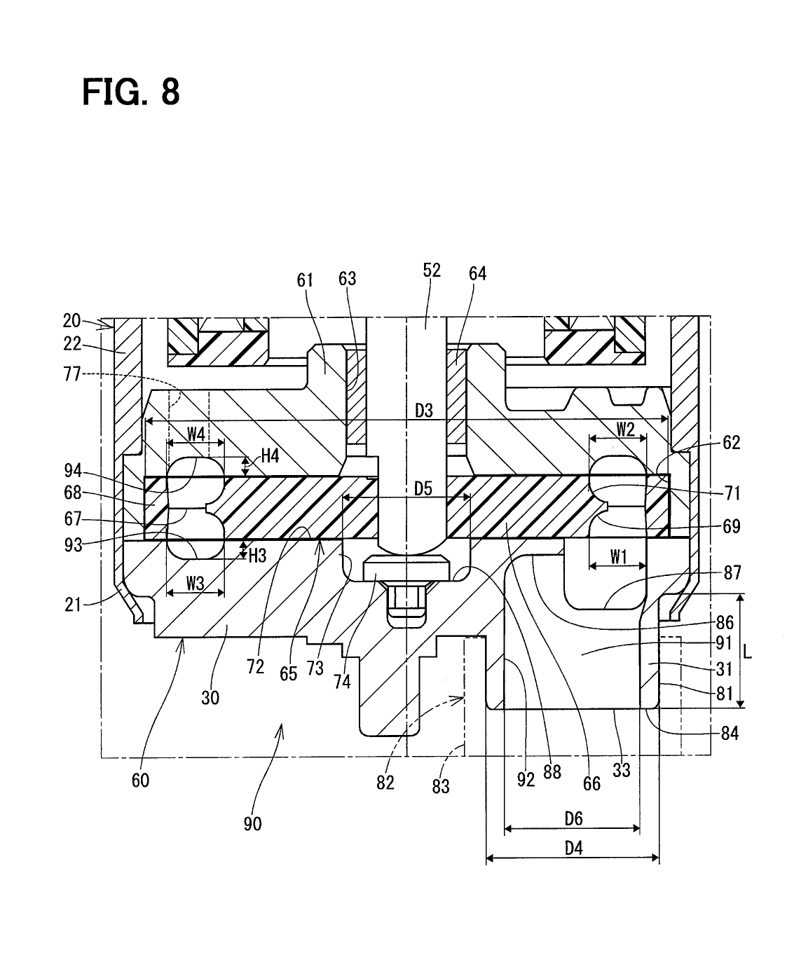

A fuel pump 90 according to the second embodiment of the present disclosure will be described with reference to FIG. 8.

### Inner Diameter of Introduction Hole of Suction Flow Path

An introduction hole 92 of a suction flow path 91 according to the second embodiment has an inner diameter D6 of 9 mm. As indicated in FIG. 5, the maximum discharge flow rate can thus be increased at high temperature. cl Ratio Between Depth and Width of Pressurization Flow Path

In the second embodiment, a suction pressurization flow path 93 has a depth H3 and a discharge pressurization flow path 94 has a depth H4. The depths H3 and H4 are 1.1 mm. The value obtained by dividing the depth H3 by a width W3 of the pressurization flow path 93 and the value obtained by dividing the depth H4 by a width W4 of the pressurization flow path 94 are 0.28. It is thus possible to achieve setting in view of pump efficiency in the case where the throttle is fully open within the range satisfying the requirement during idling and the requirement in the case where the throttle is fully open (the dimensional ratio of the pressurization flow path of 0.28 to 0.4) as indicated in FIG. 7.

### Comparison with Conventional Products

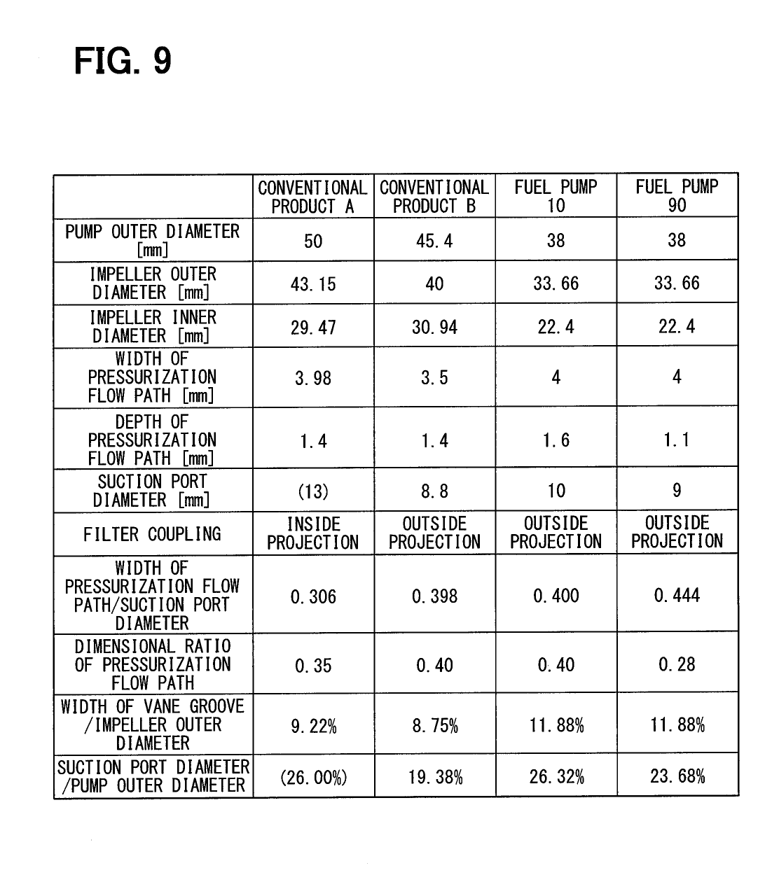

FIG. 9 indicates specifications of conventional fuel pumps “A” and “B”, the fuel pump 10 according to the first embodiment, and the fuel pump 90 according to the second embodiment. As indicated in FIG. 9, the features of the fuel pumps 10 and 90 are not provided to the conventional fuel pumps “A” and “B”.

The conventional fuel pump “A” is of a type of press fitting a connecting duct of a suction filter to the radially inside of a suction port. A fuel pump of this type has high possibility of entry of foreign matter such as resin cut shavings generated by press fitting into a pump chamber during press fitting and a high risk of an engine stall due to lock of the pump chamber, caused by foreign matter that is generated during the process and is likely to enter the pump chamber. In contrast, the first and second embodiments achieve the configuration preventing such a risk by sealing at the outer surface of the projection so as to improve performance at high temperature.

### Other Embodiments

According to a different embodiment of the present disclosure, the introduction hole of the suction flow path and the flow path section of the recess are not limited to the circular shape, but can have an elliptical shape, a polygonal shape, or the like. In this case, the “inner diameter” corresponds to the “minimum inner diameter”.

The introduction hole according to a different embodiment of the present disclosure can have the inner diameter D2 of less than 9 mm.

In a different embodiment of the present disclosure, the ratio of the width W1 of the suction vane groove to the outer diameter D3 of the impeller and the ratio of the width W2 of the discharge vane groove to the outer diameter D3 can be less than 10%.

The projection of the suction end cover according to a different embodiment of the present disclosure can have the outer diameter D4 of more than 12 mm.

The dimensional ratio of the pressurization flow path according to a different embodiment of the present disclosure can be less than 0.28 or more than 0.4.

The recess of the suction end cover according to a different embodiment of the present disclosure can have the inner diameter D5 of more than 8.5 mm.

The projection of the suction end cover according to a different embodiment of the present disclosure can have the length L of less than 3.5 mm.

The suction end cover according to a different embodiment of the present disclosure can be made of a material such as resin other than aluminum alloy.

The number of the impeller vanes according to a different embodiment of the present disclosure can be other than 41.

The present disclosure is not limited to the embodiments described above but can be achieved in various modes within the range not departing from the purpose of the invention.

1. A fuel pump configured to suction, pressurize, and discharge fuel, the fuel pump comprising:
a cylindrical housing
a suction end cover provided at a first end of the housing, and having a cylindrical projection extending outward from the housing and a suction flow path penetrating the projection and communicable with an exterior;
a discharge end cover provided at a second end of the housing and having a discharge flow path communicable with the exterior;
a brushless motor provided between the suction end cover and the discharge end cover in the housing;
a casing defining a pump chamber that partitions between the suction end cover and the casing in the housing and communicates with the suction flow path, and having a discharge hole penetrating from the pump chamber to the discharge end cover; and
an impeller rotatably provided in the pump chamber and including a disc-shaped boss torque-transmittably coupled to an end of an output shaft of the brushless motor, the output shaft inserted through the casing and extending into the pump chamber, a plurality of vanes projecting radially outward from the boss in different directions, and an annular ring surrounding the vanes,
wherein
the suction end cover has a recess depressed opposite to the impeller from a slide inner surface slidable with respect to the impeller,
the recess of the suction end cover has a bottom provided with a thrust bearing receiving the end of the output shaft,
the projection of the suction end cover has an outer circumferential surface serving as a sealing surface to be connected with a suction filter,
the suction flow path has an introduction hole having a bottomed cylindrical shape and extending from a distal end surface of the projection of the suction end cover toward the pump chamber, and a connection hole penetrating from the introduction hole to the pump chamber, and
assuming that the impeller has a rotational axis in an axial direction, the introduction hole has a bottom surface located between the slide inner surface of the suction end cover and a bottom surface of the recess in the axial direction.

2. The fuel pump according to claim 1, wherein the introduction hole has an inner diameter of not less than 9 mm.

3. The fuel pump according to claim 1, wherein the vanes divide a space between the boss and the ring of the impeller into a suction vane groove adjacent to the suction flow path and a discharge vane groove adjacent to the discharge hole, and
a ratio of a radial width of the suction vane groove to an outer diameter of the impeller and a ratio of a radial width of the discharge vane groove to the outer diameter of the impeller are not less than 10%.

4. The fuel pump according to claim 1, wherein the projection of the suction end cover has an outer diameter of not more than 12 mm.

5. The fuel pump according to claim 1, wherein the suction end cover has a wall adjacent to the pump chamber, and the wall has a pressurization flow path configured by a C-shaped groove extending circumferentially when viewed in the axial direction, and
a value obtained by dividing a depth of the pressurization flow path by a radial width of the pressurization flow path is from 0.28 to 0.40.

6. The fuel pump according to claim 1, wherein the recess of the suction end cover has an inner diameter of not more than 8.5 mm.

7. The fuel pump according to claim 1, wherein the number of the vanes is not less than 41.

8. The fuel pump according to claim 1, wherein the projection of the suction end cover has an axial length of not less than 3.5 mm from an outer peripheral edge of the suction end cover.

9. The fuel pump according to claim 1, wherein the suction end cover is formed by applying alumite treatment to an outer surface of an aluminum alloy molded product.
